(19) United States
(12) Patent Application Publication
(10) Pub. No.: US 2025/0109825 A1
(43) Pub. Date: Apr. 3, 2025

(54) HYDROGEN CHARGING EQUIPMENT, HYDROGEN CHARGING METHOD

(71) Applicant: TOYOTA JIDOSHA KABUSHIKI KAISHA, Toyota-shi Aichi-ken (JP)

(72) Inventor: Chiaki KATAOKA, Nagakute-shi Aichi-ken (JP)

(73) Assignee: TOYOTA JIDOSHA KABUSHIKI KAISHA, Toyota-shi Aichi-ken (JP)

(21) Appl. No.: 18/883,563

(22) Filed: Sep. 12, 2024

(30) Foreign Application Priority Data
Oct. 3, 2023 (JP) 2023-172014

(51) Int. Cl. F17C 5/06; F17C 5/00

(52) U.S. Cl. CPC F17C 5/06; F17C 5/007; F17C 2205/0326; F17C 2221/012; F17C 2250/043

(57) ABSTRACT

Suppressing unintentional lowering of the filling volume to the hydrogen tank. Before hydrogen charging to the hydrogen tank, the control of cooling the pipe by circulating a refrigerant to at least a portion of the pipe for hydrogen charging to the hydrogen tank.

### CROSS-REFERENCE TO RELATED APPLICATIONS

This application is based upon and claims the benefit of priority of the prior Japanese Patent Application No. 2023-172014, filed on Oct. 3, 2023, the entire contents of which are incorporated herein by reference.

### FIELD

The present disclosure relates to an apparatus for filling hydrogen into a hydrogen tank, a method of filling hydrogen into a hydrogen tank.

### BACKGROUND

Patent Document 1 discloses that, in a hydrogen storage unit, a plurality of hydrogen tanks are mounted on a manifold, hydrogen is filled into a plurality of tanks via a manifold, and hydrogen is supplied from a plurality of tanks via a manifold.

### CITATION LIST

### Patent Literature

Patent Literature 1: JP 2016-157522 A

### SUMMARY

### Technical Problem

When filling the hydrogen from the hydrogen filling device to a plurality of tanks, it is conceivable to fill the plurality of tanks at the same time by the branched hydrogen flow path connected to the hydrogen supply unit, for example hydrogen filling device hydrogen filling amount is reduced when placed in the field, it may not be obtained an intended hydrogen filling amount.

Accordingly, it is an object of the present disclosure to provide a hydrogen filling apparatus capable of suppressing unintended lowering of filling amount. Further, there is provided a hydrogen filling method capable of suppressing unintended filling amount decrease in the same manner.

### Solution to Problem

As a result of intensive studies, the inventors have long piping from the hydrogen supply device to the hydrogen tank when performing hydrogen charging to a plurality of hydrogen tanks, the heat capacity of the pipe itself because it is wall thickness for pressure resistance also obtained a finding that the temperature of the hydrogen when the hydrogen flows to rise. Then, the result of the examination that the unintentional filling amount lowering is caused by the increase of such hydrogen temperature was obtained, and the measures for solving this was embodied.

The present application is a hydrogen filling apparatus for filling hydrogen into a plurality of hydrogen tanks, a hydrogen supply unit for mounting a nozzle for filling hydrogen, a storage unit for mounting a plurality of hydrogen tanks, a main pipe which is a pipe extending from the hydrogen supply unit, a hydrogen supply branch pipe is a pipe extending from the main pipe to the hydrogen tank, and a control device, the control device performs control to flow the refrigerant to the main pipe before hydrogen filling to the hydrogen tank, discloses a hydrogen filling apparatus.

Refrigerant circulated by the control of the control device may be allowed to flow out of the hydrogen as a refrigerant from at least one of the hydrogen tank mounted.

At that time, the hydrogen tank to flow hydrogen as a refrigerant can be a hydrogen tank in which the main pipe refrigerant can flow at the longest distance. Incidentally, when the hydrogen remaining amount of the hydrogen tank is equal to or less than a predetermined value, it may be allowed to flow out hydrogen as a refrigerant from another hydrogen tank.

Refrigerant circulated by the control of the control device, the pre-cooled refrigerant supplied from the hydrogen supply unit may be used.

Further, the present application discloses a method for simultaneously filling hydrogen into a plurality of hydrogen tanks, prior to hydrogen charging to the hydrogen tank, to cool the pipe by circulating a refrigerant to at least a portion of the pipe for hydrogen charging to the hydrogen tank, a hydrogen charging method.

### Effects

According to the hydrogen filling apparatus and method of the present disclosure, it is possible to cool the pipe before hydrogen is filled in the hydrogen tank, hydrogen supplied during hydrogen charging is suppressed from being raised in temperature by the pipe. Thus, it is possible to suppress unintentional filling amount reduction.

### BRIEF DESCRIPTION OF DRAWINGS

FIG. 1A is a diagram illustrating a hydrogen cartridge 10.

FIG. 1B is a diagram illustrating a hydrogen cartridge 10.

FIG. 2 is an appearance of the hydrogen filling device 50.

FIG. 3 is a diagram illustrating an internal configuration of the hydrogen filling apparatus 50.

FIG. 4 is a diagram illustrating an internal configuration of the hydrogen filling device 60.

FIG. 5 is a diagram illustrating an internal configuration of the hydrogen filling apparatus 70.

### DESCRIPTION OF EMBODIMENTS

### 1. Hydrogen Tank

It will be described first hydrogen cartridge is one form of an example of a hydrogen tank in which hydrogen is filled by the hydrogen filling apparatus and method of the present disclosure.

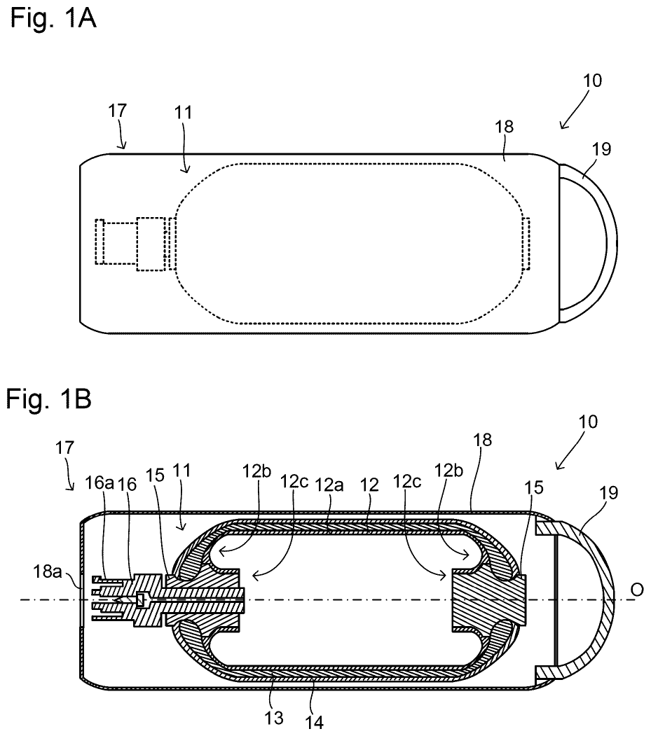

The hydrogen cartridge 10 is a container for storing hydrogen to be supplied in a liquid state or a gaseous state. FIGS. 1A and 1B show diagrams for illustration. FIG. 1A is an external view of the hydrogen cartridge 10 (the tank body 11 to be contained is represented by a dotted line.), FIG. 1B is a cross-sectional view along the direction of the axis O of the hydrogen cartridge 10. As can be seen from these figures, the hydrogen cartridge 10 in this form has a tank body 11 and a case 17

Further, the tank body 11 includes a liner 12 constituting a container body, a reinforcing layer 13, and a protective layer 14, and a mouthpiece 15 and an opening/closing valve 16 are disposed in the container body.

### 1.1. Liner

The liner 12 is one of the members constituting the container body of the tank body 11, and is a hollow member defining an internal space, and is cylindrical in this form. Liner 12, the opening at both ends of the fuselage portion 12a whose diameter is substantially constant is narrowed by the dome-shaped side-end 12b, the mouthpiece 15 is disposed in the narrowed opening 12c.

It is sufficient that the liner 12 is made of a material capable of holding hydrogen contained in its internal space without leaking, and a known material can be used. Specifically, for example, a nylon resin, a polyethylene-based synthetic resin, or made of a metal such as stainless steel or aluminum. In some embodiments, the material constituting the liner is a synthetic resin from the viewpoint of weight reduction.

The thickness of the liner 12 is not particularly limited, but, in some embodiments, is 0.5 mm˜3.0 mm

### 1.2. Reinforcement Layer

The reinforcing layer 13 is one of members constituting the container body, and a fiber is laminated over a plurality of layers, and a cured resin is impregnated into the fiber. A layer made of fibers is formed by winding a fiber bundle over a plurality of layers to a predetermined thickness on an outer periphery of a liner 12. Although the thickness of the reinforcing layer 13 and the number of turns of the fiber bundle are determined by the required strength, they are not particularly limited, but may be about 10 mm˜30 mm degree.

### [Fiber Bundles]

For example, carbon fibers are used for the fiber bundle of the reinforcing layer 13, and the fiber bundle has a band shape in which carbon fibers form a bundle and have a predetermined cross-sectional shape (e.g., a rectangular cross section). Although not particularly limited, there may be mentioned a rectangular shape having a 6 mm˜20 mm cross section and a 0.1 mm˜0.3 mm thickness. The amount of carbon fibers contained in the fiber bundle is not particularly limited, and examples thereof include a carbon fiber of about 36000

### [Impregnated Resin]

The resin impregnated and cured in the fiber (fiber bundle) in the reinforcing layer 13 is not particularly limited as long as it can increase the strength of the fiber by this. Examples thereof include a thermosetting resin which is cured by heat, and specific examples thereof include an amine-based or anhydride-based curing accelerator and an epoxy resin containing a rubber-based reinforcing agent, an unsaturated polyester resin, and the like. In addition, a resin composition containing an epoxy resin as a main agent and cured by mixing a curing agent thereto can be also mentioned. According to this, it is automatically cured by allowing the resin composition which is the mixture to reach and penetrate the fiber layer between the time when the main agent and the curing agent are mixed and cured.

### 1.3. Protective Layer

If necessary, a protective layer 14 may be disposed on the outer periphery of the reinforcing layer 13 as one of the members constituting the container body. When provided, for example, glass fibers are wound and impregnated with a resin. The resin to be impregnated can be considered similarly to the reinforcing layer 13. Thus, it is possible to impart impact resistance to the tank body 11.

The thickness of the protective layer 14 is not particularly limited, but may be about 1.0 mm˜1.5 mm

### 1.4. Mouthpiece

Mouthpiece 15 is a member which is attached to each of the two opening 12c of the liner 12 is disposed at each of the axial line ◯ of the liner 12, the mouthpiece 15 on one end side of the container body opening and closing valve 16 is disposed with functions as an opening for communicating the inside and outside. The other end side mouthpiece 15 is closed. The member constituting the base 15 is not particularly limited as long as it has the necessary strength, and examples thereof include stainless steel and aluminum.

### 1.5. Open/Close Valve

The on-off valve 16 is closed when the hydrogen cartridge 10 is not mounted in the hydrogen filling apparatus 50, is opened by being pressed by the push rod of the connecting device 55 when the hydrogen cartridge 10 is mounted in the hydrogen filling apparatus 50 (not shown).

The distal end of the on-off valve 16, on the side connected to the hydrogen filling device 50, and has a connecting portion 16a connected to the hydrogen filling apparatus 50. The connecting portion 16a is a portion where the connecting portion 16a and the connecting device 55 of the hydrogen-filling device 50 can be engaged and disengaged. The specific aspect is not limited, but a mechanical coupling (mechanical interface) can be exemplified in the present embodiment, among which a mount such as connecting a photographing lens to the main body in the camera can be applied, and more specifically, it is possible to use the C mount. Therefore, in this form, the connecting portion 16a is connected to the connecting device 55 of the hydrogen charging device 50 while the hydrogen cartridge 10 is rotated about the axial line ◯.

### 1.6. Case

Case 17 is a member that contains the tank body 11 to form the outer shell of the hydrogen cartridge 10, and has a housing 18 and a handle 19.

Housing 18 is a cylindrical member, and is configured to be able to store the tank body 11 inside thereof. In the housing 18 is provided with a hole 18a at a position where the opening and closing valve 16 of the stored tank main body 11 is opposed, it is configured to be able to access the opening and closing valve 16 from the outside.

The handle 19 is an arch-shaped member disposed at an end of the housing 18 opposite to the side on which the opening/closing valve 16 of the tank main body 11 is disposed. The user can carry the hydrogen cartridge 10 with the handle 19 or perform the operation of attaching/detaching the hydrogen cartridge 10 to/from the hydrogen filling device 50.

### 1.7. Other

The allowable pressure of the tank body 11 is not particularly limited, but a tank in which hydrogen can be stored at an allowable pressure of 70 MPa or less beyond 20 MPa may be exemplified from the viewpoint of being relatively easy to carry and capable of storing more hydrogen. At the time of hydrogen charging, the higher the temperature at the time of 70 MPa arrival, the lower the charging rate (the pressure drop at room temperature becomes larger).

### 2. Structure and Control of Hydrogen Filling Device

Next, the structure of the hydrogen filling apparatus according to each form, and control will be described. Although an embodiment in which hydrogen is filled in the hydrogen cartridge described above will be described here, the hydrogen tank which is an object to be filled with hydrogen is not limited to the hydrogen cartridge described above, and may be a hydrogen tank of another known form.

### 2.1. Form Example 1

### 2.1.1. Structure

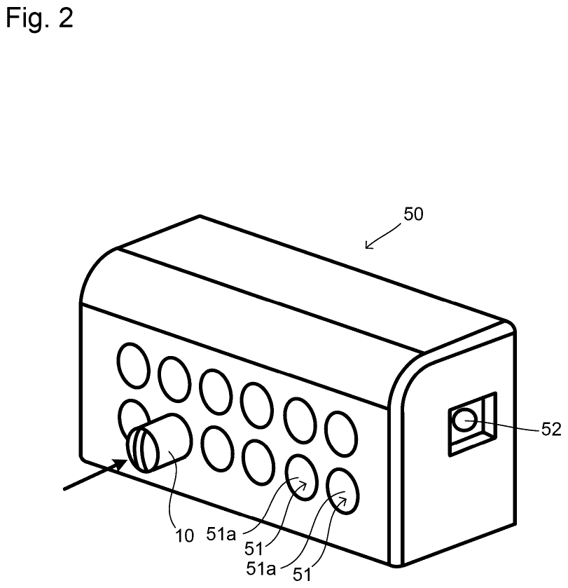

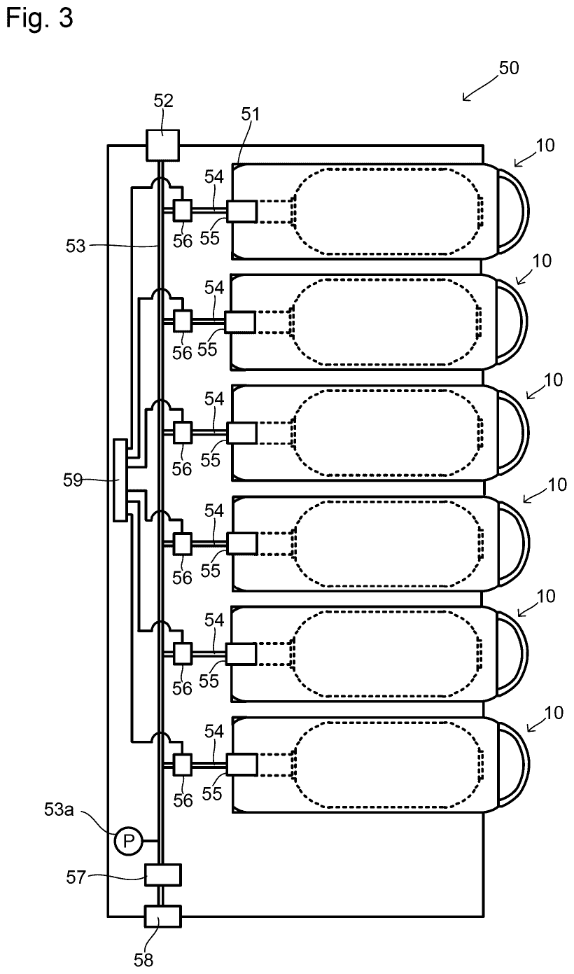

FIG. 2 is a perspective view of the appearance of the hydrogen filling device 50 according to Form Example 1, FIG. 3 is a diagram schematically representing the internal configuration of the hydrogen filling device 50 (upper stage of the storage portion 51 of the upper and lower two stages in FIG. 2).

The hydrogen filling device 50 is a device for filling hydrogen into the hydrogen cartridge 10. In other words, it is configured such that the hydrogen cartridge 10 in which hydrogen is consumed is mounted and can be detached after the hydrogen cartridge 10 is filled with hydrogen.

Therefore, the hydrogen filling apparatus 50 includes a housing portion 51, the hydrogen supply unit 52, the main pipe 53, the hydrogen supply branch pipe 54, the connecting device 55, the solenoid valve 56, the valve 57, the hydrogen discharge unit 58, and a control device 59.

It will be described in more detail below for.

### [Storage Part]

The storage portion 51 is a portion where the hydrogen cartridge 10 is stored when the hydrogen cartridge 10 is connected to the hydrogen filling device 50. FIG. 2 schematically shows a situation in which the hydrogen cartridge 10 is to be stored in one storage portion 51. FIG. 3 shows a situation in which hydrogen cartridges 10 are mounted on all of the plurality of arranged storage portions 51.

As can be seen from these figures, the storage portion 51 is a space in which the hydrogen cartridge 10 is disposed, and is a space surrounded by an inner wall having an opening 51a in which the hydrogen cartridge 10 can be taken in and out. The connecting device 55 is disposed at the bottom of the housing portion 51 opposite to the opening 51a.

In this form, the storage portion 51 is provided with 6 storage portions 51 at each stage in the upper and lower 2 stages, but the number of the storage portions 51 is not particularly limited.

### [Hydrogen Supply Section]

The hydrogen supply unit 52 is a supply port for supplying hydrogen to be filled in the hydrogen cartridge 10 to the hydrogen filling device 50. Thus, the hydrogen supply unit 52 connecting member of the hydrogen supply pipe extending from the hydrogen supply device such as a hydrogen station (sometimes referred to as a nozzle) is connected. A receptacle may be cited as a typical form of hydrogen supply 52.

### [Main Piping]

The main pipe 53 is a pipe through which hydrogen connecting from the hydrogen supply unit 52 to the hydrogen discharge unit 58, the hydrogen supply branch pipe 54 is branched from the main pipe 53.

The main pipe 53 is pressure gauge 53a is provided, it may be configured to be able to know the internal pressure.

### [Hydrogen Supply Branch Pipe and Connecting Device]

Hydrogen supply branch pipe 54 branches from the main pipe 53, a pipe extending toward each housing portion 51. Hydrogen supply branch pipe 54 is a pipe through which hydrogen to be filled in the hydrogen cartridge 10, and supplies hydrogen to the connecting device 55.

Connecting device 55, at the bottom of the housing portion 51, is disposed at a connection portion between the tank body 11 of the hydrogen cartridge 10 of the hydrogen supply branch pipe 54, connected to the opening and closing valve 16 of the tank body 11 described above, the opening and closing of the opening and closing valve 16 of the tank body 11 operation to flow hydrogen into the tank body 11.

Connecting device 55 in this form has a rod-shaped push rod disposed in the housing portion 51 (not shown), the hydrogen from the hydrogen supply branch pipe 54 while the push rod presses the valve body of the on-off valve 16 when the hydrogen cartridge 50 is housed in the housing portion 51 while opening the on-off valve 16 can flow into the tank body 11.

Further, the connecting device 55 in this form has a connected portion engaged with the connecting portion 16a provided at the distal end of the on-off valve 16 (not shown). The form of the part to be connected is a form adapted to the form of the connecting portion 16a.

### [Solenoid Valve]

Solenoid valve 56 is an on-off valve provided in each hydrogen supply branch pipe 54, it is possible to solenoid control. In this form the solenoid valve 56 is electrically connected to the controller 59, the open-close state is controlled based on a signal from the controller 59.

In the present embodiment, it has been decided to switch the opening and closing of the hydrogen supply branch pipe 54 by providing the solenoid valve 56, not limited to this, the push rod provided in the connecting device 55 is configured to be electrically controlled open and close control, it may also serve as a solenoid valve.

### [Valve and Hydrogen Discharge Section]

Valve 57 is a switching valve provided in the main pipe 53, it is possible to discharge the hydrogen to the outside from the hydrogen discharge unit 58 by opening the valve 57. On the other hand, when the valve 57 is closed, the discharge of hydrogen from the hydrogen discharge unit 58 to the outside is regulated.

The valve 57 may be a valve that can be opened and closed manually, or may be a valve that opens and closes by an electrical signal. When configured to open and close by an electrical signal is electrically connected to the control device 59, the open and close state may be controlled by the control device 59.

### [Control Unit]

Control device 59 in this form is a control device for individually controlling the opening and closing of each of the plurality of solenoid valves 56. More specifically, in this form, after the hydrogen cartridge 10 is mounted on the hydrogen control device 50, the control device 59 controls the opening and closing of the electromagnetic valve 56 (or an electrically controllable push rod (hereinafter, sometimes referred to as “electromagnetic push rod”) before the hydrogen is filled. The details of the specific control will be described later. However, it is not necessary to be a control device only for that, it can be provided with other functions to control the hydrogen filling apparatus 50.

Although there is no particular limitation on the mode of the control device 59, it can typically be constituted by a computer.

The computer includes a CPU (Central Processing Unit that is a processor, a RAM (Random Access Memory that serves as a workspace, a ROM (Read-Only Memory as a storage medium, a receiver that is an interface that accepts information to a computer, whether wired or wireless, and an output that is an interface that sends information from the computer to the outside, whether wired or wireless.

The receiving unit is connected to a device for transmitting a signal of filling start hydrogen cartridge 10 is mounted, for example in the hydrogen filling apparatus 50. On the other hand, the solenoid valve 56 (or the solenoid push rod) is communicatively connected to the output unit, so that the opening and closing of the solenoid valve 56 (or the solenoid push rod) can be controlled.

In the computer, each process for control performed by the hydrogen filling apparatus 50 of the present embodiment is defined as a specific instruction, and a computer program for performing the process is stored. In computers, CPU, RAM as a hardware resource and ROM and computer programs work together. Specifically, CPU implements the function by executing a computer program recorded in ROM on the basis of the fill-start signaling acquired through the receiver in a RAM that functions as a workspace. The data acquired or generated by CPU is stored in RAM. Then, based on the obtained result, an instruction is transmitted to the electromagnetic valve 56 (or electromagnetic push rod) via the output unit if necessary.

### 2.1.2. Control (Hydrogen Filling Method)

Next, a method of filling hydrogen into the hydrogen cartridge 10 by control of the control device 59 of the hydrogen filling device 50 will be described.

In the hydrogen charging device 50 in the initial state, the solenoid valve 56 (or solenoid push rod), and the valve 57 is in the closed position. When the control unit 59 receives a signal indicating that the hydrogen cartridge 10 is mounted to the hydrogen filling device 50 from this condition, or when the control unit 59 receives a signal for starting hydrogen filling after mounting, before hydrogen is filled, the control unit 59 sets the solenoid valve 56 (or the electromagnetic push rod) to an open state. Thus hydrogen remaining in the installed hydrogen cartridge 10 is allowed to flow into the main pipe 53.

The valve 57 is then opened manually or under the control of the controller 59.

Thus, hydrogen remaining in the hydrogen cartridge 10 flows through the main pipe 53. This is accompanied by adiabatic expansion of the hydrogen in the hydrogen cartridge 10. Therefore, since the temperature of hydrogen is lowered, hydrogen flowing through the main pipe 53 functions as a refrigerant because the temperature is low, it is possible to cool the main pipe 53.

Then, after a lapse of a fixed time in the release of hydrogen from the hydrogen cartridge 10 (cooling of the main pipe 53), the valve 57 is closed, and hydrogen is supplied from the hydrogen supply unit 52 to perform hydrogen filling into the hydrogen cartridge 10. The temperature of the hydrogen supplied from the hydrogen supply unit 52 for the main pipe 53 is already cooled at the time of the hydrogen charging (hydrogen supplied is in the normal cooling state.) is raised by the main pipe 53 is suppressed. Thus, it is possible to suppress unintentional filling amount decrease due to the increase in hydrogen temperature.

Further, since the main pipe 53 can be filled with hydrogen before filling of hydrogen into the hydrogen cartridge 10, even if air is mixed in the main pipe 53 when the hydrogen cartridge 10 is temporarily mounted, it is also possible to prevent air from entering the hydrogen cartridge 10.

In this form, hydrogen remaining in the hydrogen cartridge 10 is used as a refrigerant. Therefore, the cooling is performed in the range of residual hydrogen of the attached hydrogen cartridge 10. When a plurality of hydrogen cartridges 10 are mounted, hydrogen can be flowed out into the main pipe 53 in order or simultaneously from one hydrogen cartridge 10 selected from a plurality of the hydrogen cartridges 10.

In addition, when the residual hydrogen amount of the hydrogen cartridge 10 is known, it is more effective to attach the hydrogen cartridge 10 having the largest residual hydrogen amount to the storage portion 51 which is far from the hydrogen discharge portion 58 (the main pipe 53 can flow hydrogen the longest).

### 2.2. Form Example 2

In Form Example 2, the control (hydrogen filling method) is different from that of Form Example 1 described above. Since the configuration of the device can be considered in the same manner as in Form Example 1, a control (hydrogen filling method) according to Form Example 2 will be described here.

In the hydrogen charging device 50 in the initial state, the solenoid valve 56 (or solenoid push rod), and the valve 57 is in the closed position. In this form, even if the control unit 59 receives a signal that the hydrogen cartridge 10 is mounted to the hydrogen filling apparatus 50 from this condition, or even if the control unit 59 receives a signal of hydrogen filling start after mounting, the control unit 59 maintains the closed state of the solenoid valve 56 (or the electromagnetic push rod).

On the other hand, the valve 57 is opened manually or under the control of the controller 59.

Next, supplying the refrigerant from the hydrogen supply unit 52. The refrigerant, since the hydrogen supplied from the hydrogen station or the like is in a pre-cooled state, it is possible to cool the main pipe 53 by the hydrogen that is cooled in advance flows through the main pipe 53 as a refrigerant.

Then, the refrigerant supply from the hydrogen supply unit 52 (cooling of the main pipe 53) closes the valve 57 after a predetermined time has elapsed, the solenoid valve 56 (or solenoid push rod) by the control device 59 is controlled to open state, hydrogen from the hydrogen supply unit 52 performs hydrogen filling of the hydrogen cartridge 10. During this hydrogen filling, the temperature of the hydrogen supplied from the hydrogen supply unit 52 because the main pipe 53 is already cooled is suppressed to rise by the main pipe 53. Thus, it is possible to suppress unintentional filling amount decrease due to the increase in hydrogen temperature.

Further, since the main pipe 53 can be filled with hydrogen before filling of hydrogen into the hydrogen cartridge 10, even if air is mixed in the main pipe 53 when the hydrogen cartridge 10 is temporarily mounted, it is also possible to prevent air from entering the hydrogen cartridge 10.

### 2.3. Form Example 3

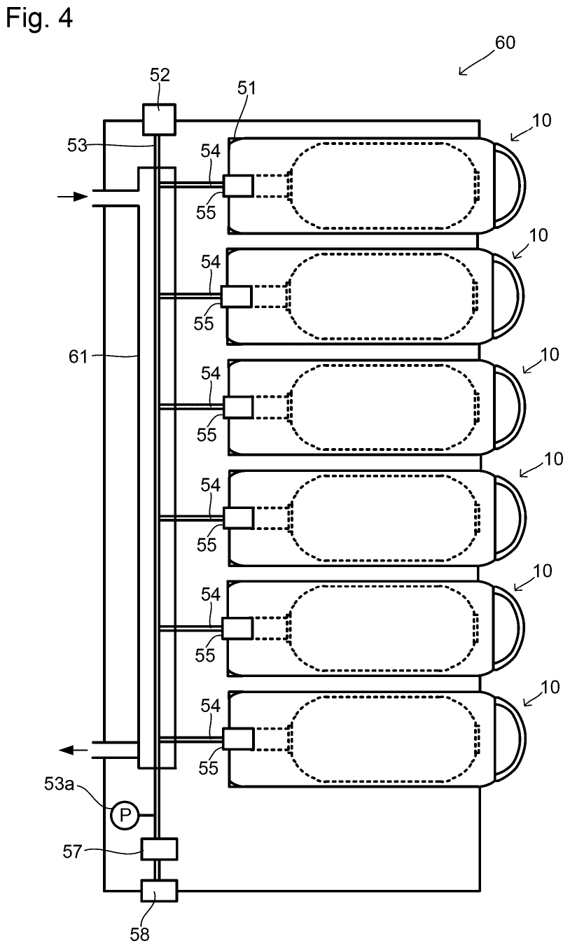

In Form Example 3, using the hydrogen filling device 60 shown in FIG. FIG. 4 shows a schematic diagram of the structure of the device (a diagram from the same viewpoint as that shown in FIG. 3). Specifically, the hydrogen filling device 60, the cooling pipe 61 is provided in place of the solenoid valve 56 and the controller 59 with respect to the hydrogen filling apparatus 50. Other devices can be considered similar to the hydrogen filling device 50.

Cooling pipe 61 forms a flow path such as to surround at least a portion of the main pipe 53 from the outside as can be seen from FIG. 4 (a double pipe structure). And before the filling of the hydrogen to at least the hydrogen cartridge 10, and, if necessary, to cool the main pipe 53 by flowing a refrigerant to the cooling pipe 61 during hydrogen charging. The refrigerant used is not particularly limited, and a gas or a liquid capable of functioning as a refrigerant may be appropriately selected.

According to this, it is suppressed that the temperature of the hydrogen supplied from the hydrogen supply unit 52 because the main pipe 53 is already cooled during hydrogen filling to the hydrogen cartridge 10 is raised by the main pipe 53. Thus, it is possible to suppress unintentional filling amount decrease due to the increase in hydrogen temperature. Here has been described to actively cool the main pipe 53 using the cooling pipe 61, it is also possible to suppress the temperature rise of the main pipe 53 by suppressing receiving heat from the outside by surrounding the main pipe 53 with heat insulating material instead.

### 2.4. Form Example 4

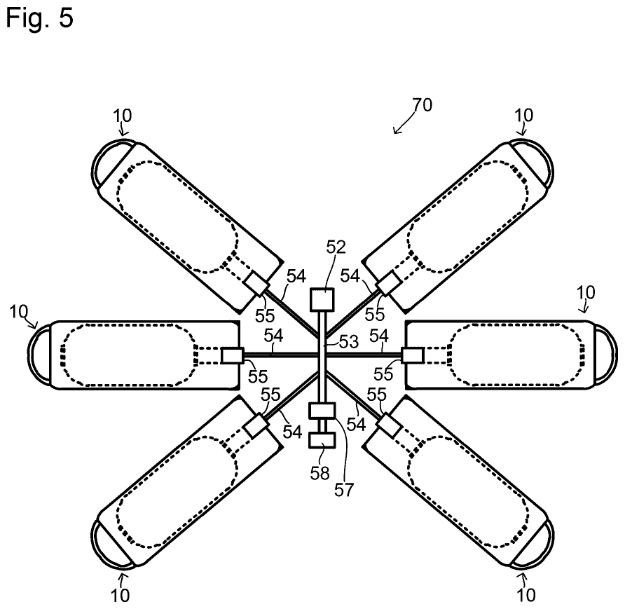

FIG. 5 schematically shows the configuration of the hydrogen filling apparatus 70 according to the Form Example 4. The reference numerals shown in FIG. 5 can be considered similar to the hydrogen filling apparatus 50 described above.

In the Form Example 4, the mounting direction of the plurality of hydrogen cartridges 10 and the radial, is obtained by shortening the main pipe 53. The volume of the main pipe (heat capacity) can be kept small by shortening the main pipe 53, the temperature of the hydrogen supplied from the hydrogen supply unit 52 without necessarily cooling is suppressed from being raised by the main pipe 53. Thus, it is possible to suppress unintentional filling amount decrease due to the increase in hydrogen temperature. However, not only Form Example 4,but also any of Form Example 1 to Form Example 3 described above may be used in combination.

In the form in which the mounting direction of the hydrogen cartridge 10 is radially, the mounting direction may be a radial direction of a sphere or a circle, and the arrangement direction of the plurality of hydrogen cartridges 10 may be a direction along a spherical surface or a direction along a circumference.

### REFERENCE SIGNS LIST

10 . . . 1 . . . Hydrogen tank, 12 . . . tank body, 14 . . . Protective layer, 14 . . . Capacitor, 16 . . . Switching valve, 17 . . . case, 50 . . . Hydrogen charging device, 51 . . . Hydrogen supply unit, 53 . . . Main piping, 54 . . . Hydrogen supply branch piping, 55 . . . Connecting device, 56 . . . Solenoid valve, 57 . . . Valve, 58 . . . Hydrogen discharge unit, 59 . . . Control device, 60 . . . Hydrogen charging device, 61 . . . Cooling tube, 70▪Hydrogen charging equipment

What is claimed is:

1. A hydrogen filling apparatus configured to fill a plurality of hydrogen tanks with hydrogen, the hydrogen filling apparatus comprising:
a hydrogen supply part to which a nozzle for hydrogen filling is to be attached;
storage units into which a plurality of hydrogen tanks are to be installed;
a main pipe that is a pipe extending from the hydrogen supply part;
hydrogen supply branch pipes that are pipes extending from the main pipe to the hydrogen tanks when the hydrogen tanks are installed; and
a control unit, wherein
the control unit controls a refrigerant to circulate through the main pipe before the hydrogen filling of the hydrogen tanks.

2. The hydrogen filling apparatus according to claim 1, wherein as the refrigerant circulating according to the control of the control unit, hydrogen is run off at least one of the hydrogen tanks among the installed hydrogen tanks.

3. The hydrogen filling apparatus according to claim 2, wherein the hydrogen tank which the hydrogen as the refrigerant is run off is a hydrogen tank that allows the refrigerant to flow in the main pipe in a longest length.

4. The hydrogen filling apparatus according to claim 3, wherein when a remaining amount of the hydrogen in the hydrogen tank is at most a predetermined value, hydrogen as the refrigerant is run off another hydrogen tank.

5. The hydrogen filling apparatus according to claim 1, wherein a refrigerant that is supplied from the hydrogen supply unit, and is cooled in advance is used as the refrigerant.

6. A method of filling a plurality of hydrogen tanks with hydrogen at a same time, the method comprising:
circulating a refrigerant through at least part of a pipe to cool the pipe before hydrogen filling of hydrogen tanks, the pipe being for filling the hydrogen tanks with hydrogen.
